(19) United States
(12) Patent Application Publication
(10) Pub. No.: US 2013/0121559 A1
(43) Pub. Date: May 16, 2013

(54) MOBILE DEVICE WITH THREE DIMENSIONAL AUGMENTED REALITY

(71) Applicants: Xiaoyan HU, Edgewater, NJ (US); Chang YUAN, Camas, WA (US)

(72) Inventors: Xiaoyan HU, Edgewater, NJ (US); Chang YUAN, Camas, WA (US)

(73) Assignee: SHARP LABORATORIES OF AMERICA, INC., Camas, WA (US)

(21) Appl. No.: 13/298,228

(22) Filed: Nov. 16, 2011

(51) Int. Cl. G06K 9/00

(52) U.S. Cl. 382/154

(57) ABSTRACT

A method for determining an augmented reality scene by a mobile device includes estimating 3D geometry and lighting conditions of the sensed scene based on stereoscopic images captured by a pair of imaging devices. The device accesses intrinsic calibration parameters of a pair of imaging devices of the device independent of a sensed scene of the augmented reality scene. The device determines two dimensional disparity information of a pair of images from the device independent of a sensed scene of the augmented reality scene. The device estimates extrinsic parameters of a sensed scene by the pair of imaging devices, including at least one of rotation and translation. The device calculates a three dimensional image based upon a depth of different parts of the sensed scene based upon a stereo matching technique. The device incorporates a three dimensional virtual object in the three dimensional image to determine the augmented reality scene.

### CROSS-REFERENCE TO RELATED APPLICATIONS

None.

### BACKGROUND OF THE INVENTION

A plethora of three dimensional capable mobile devices are available. In many cases, the mobile devices may be used to obtain a pair of images using a pair of spaced apart imaging devices, and based upon the pair of images create a three dimensional view of the scene. In some cases, the three dimensional view of the scene is shown on a two dimensional screen of the mobile device or otherwise shown on a three dimensional screen of the mobile device.

For some applications, an augmented reality application incorporates synthetic objects in the display together with the sensed three dimensional image. For example, the augmented reality application may include a synthetic ball that appears to be supported by a table in the sensed scene. For example, the application may include a synthetic picture frame that appears to be hanging on the wall of the sensed scene. While the inclusion of synthetic objects in a sensed scene is beneficial to the viewer, the application tends to have difficulty properly positioning and orientating the synthetic objects in the scene.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a mobile device with a stereoscopic imaging device.

FIG. 2 a three dimensional imaging system.

FIG. 3 a mobile device calibration structure.

FIG. 4 illustrates a radial distortion.

FIG. 5 illustrates single frame depth sensing.

FIG. 6 illustrates multi-frame depth sensing.

FIG. 7 illustrates a pair of planes to determine the three dimensional characteristics of a sensed scene.

### DETAILED DESCRIPTION OF PREFERRED EMBODIMENT

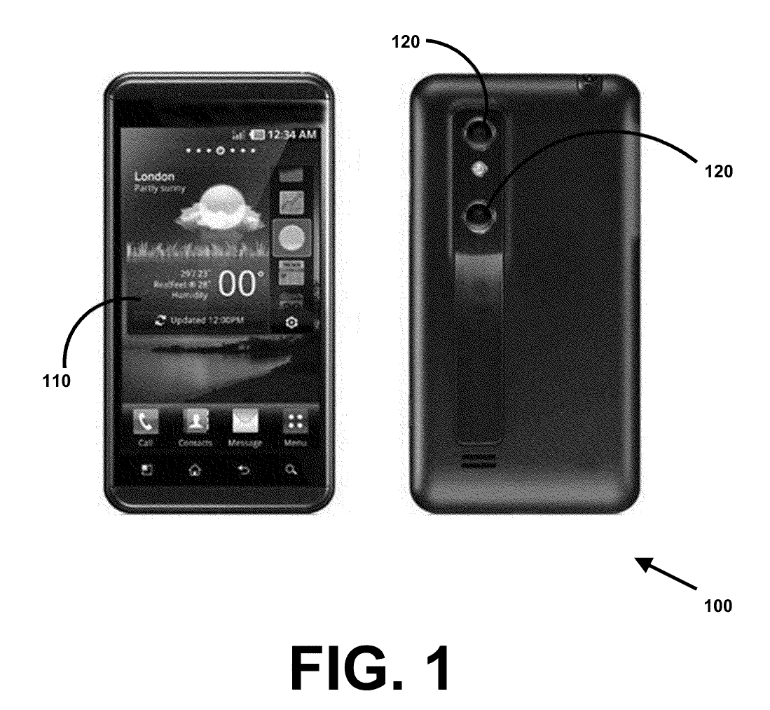

Referring to FIG. 1, a mobile device 100 includes a processor, a memory, a display 110, together with a three dimensional imaging 120 device may be used to sense a pair of images of a scene or a set of image pairs of the scene. For example, the mobile device may include a cellular phone, a computer tablet, or other generally mobile device. The imaging devices sense the scene, then in combination with a software application operating at least in part on the mobile device, renders an augmented reality scene. In some cases, the application on the phone may perform part of processing, while other parts of the processing are provided by a server which is in communication with the mobile device. The resulting augmented reality scene includes at least part of the sensed sense by the imaging devices together with synthetic content.

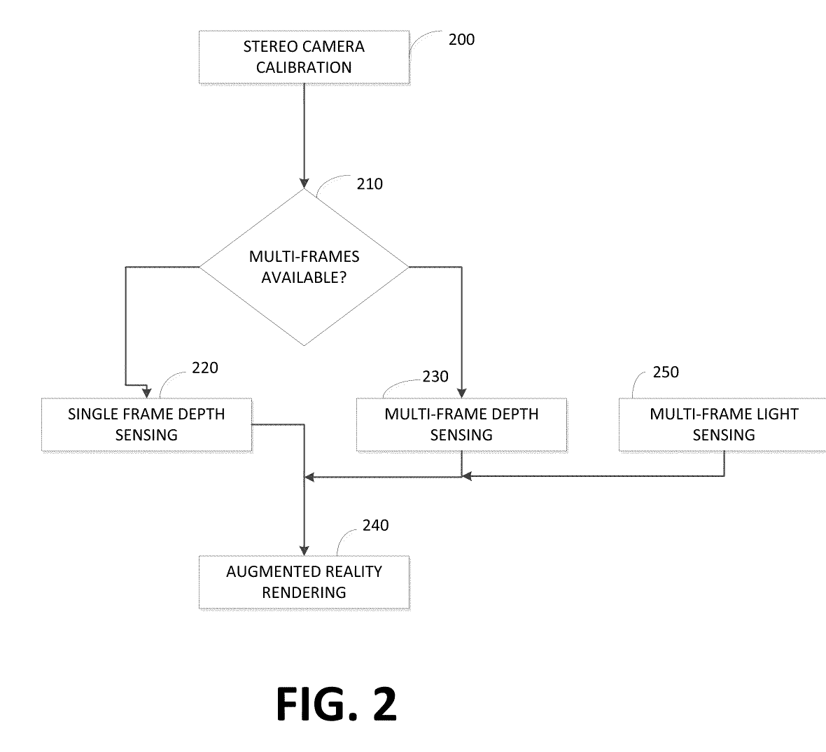

Referring to FIG. 2, a technique to render an augmented reality scene is illustrated. The pair of imaging devices 120, generally referred to as a stereo camera, is calibrated 200 or otherwise provided with calibration data. The calibration of the imaging devices provides correlation parameters intrinsic to the camera device between the captured images and the physical scene observed by the imaging devices.

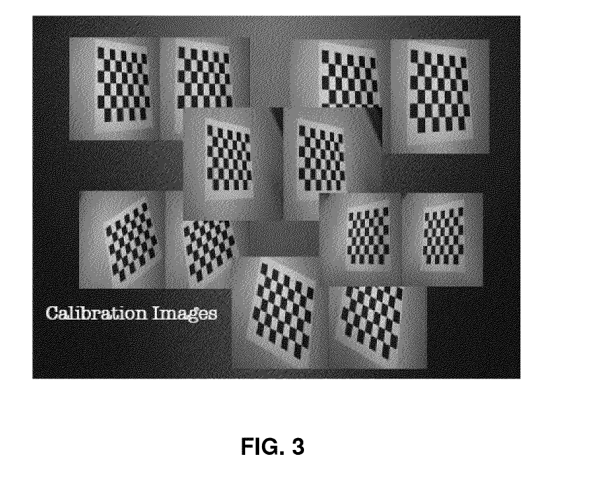

Referring also to FIG. 3, one or more calibration images may be sensed by the imaging devices on the mobile device 100 from a known position relative to the calibration images. Based upon the one or more calibration images the calibration technique may determine the center of the image, determine the camera's focal length, determine the camera's lens distortion, and/or any other intrinsic characteristics of the mobile device 100. The characterization of the imaging device may be based upon, for example, a pinhole camera model using a projective transformation as follows:

$$[ \begin{matrix}x \\ y \\ 1\end{matrix} ] = [ \begin{matrix}fx & 0 & px \\ 0 & fy & py \\ 0 & 0 & 1\end{matrix} ] \times [ \begin{matrix}R 00 & R 01 & R 02 & T 0 \\ R 10 & R 11 & R 12 & T 1 \\ R 20 & R 21 & R 22 & T 2\end{matrix} ] \times [ \begin{matrix}{X}^{′} \\ {Y}^{′} \\ {Z}^{′} \\ 1\end{matrix} ]$$

$$where [ \begin{matrix}x \\ y \\ 1\end{matrix} ]$$

is a projected two dimensional point, where

$$[ \begin{matrix}fx & 0 & px \\ 0 & fy & py \\ 0 & 0 & 1\end{matrix} ]$$

is an intrinsic matrix of the camera characteristics with fx and fy being focal lengths in pixels in the x and y direction, where px and py is the image center, where

$$[ \begin{matrix}R 00 & R 01 & R 02 & T 0 \\ R 10 & R 11 & R 12 & T 1 \\ R 20 & R 21 & R 22 & T 2\end{matrix} ]$$

is an extrinsic matrix of the relationship between the camera and the object being sensed with R being a rotation matrix and T being a translation matrix, and where

$$[ \begin{matrix}{X}^{′} \\ {Y}^{′} \\ {Z}^{′} \\ 1\end{matrix} ]$$

is a three dimensional point in a homogeneous coordinate system. Preferably, such characterizations are determined once, or otherwise provided once, for a camera and stored for subsequent use.

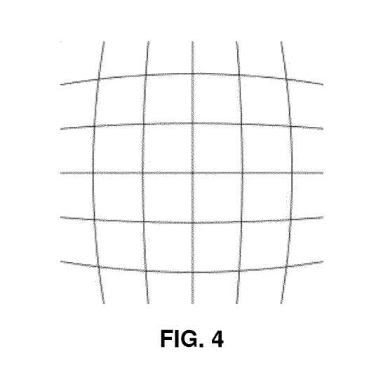

In addition, the camera calibration may characterize the distortion of the image which may be reduced by suitable calibration. Referring also to FIG. 4, one such distortion is a radial distortion which is independent of the particular scene being viewed, so therefore it is preferably determined for a camera once, or otherwise provided once, and stored for subsequent use. For example, the following characteristics may be used to characterize the radial distortion:

xᵤ=x_{d}+(x_{d}−x_{c})(K₁r²+K₂r⁴+ . . . )

yᵤ=y_{d}+(y_{d}−y_{c})(K₁r²+K₂r⁴+ . . . )

where xᵤ and yᵤ are undistorted coordinates of a point, where x_{d} and y_{d} are corresponding points with distortion, where x_{c} and y_{c} are distortion centers, where Kₙ is a distortion coefficient for the n-th term, and where r represents the distance from (x_{d}, y_{d}) to (pₓ, p_{y}).

The process of calibrating a camera may involve obtaining several images of one or more suitable patterns from different viewing angles and distances, then the corners or other features of the pattern may be extracted. For example, the extraction process may be performed by a feature detection process using sub-pixel accuracy. The extraction process may also estimate the three dimensional locations of the feature points by using the aforementioned projection model. The estimated locations may be optimized together with the intrinsic parameters by iterative gradient descent on Jacobian matrices so that re-projection errors are reduced. The Jacobian matrices may be partial derivatives of the image point coordinates with respect to intrinsic parameters and camera distortions.

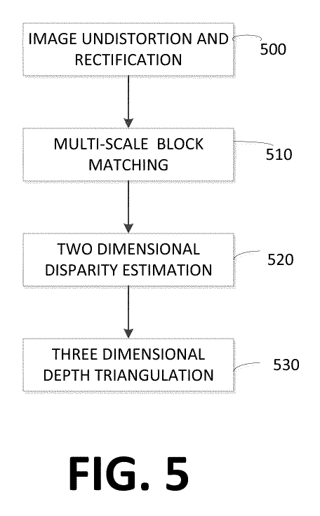

Referring again to FIG. 2, after calibrating each of the imaging devices the system may determine if multiple frames are available 210. If only a pair of stereoscopic images are available, then a single frame depth sensing process 220 may be used. Referring to FIG. 5, the single frame depth sensing 220 includes a stereo process that may be performed to estimate suitable transformations between the two imaging devices for two dimensional disparity estimation to estimate the depth of the scene. The intrinsic parameters and distortion coefficients may be used to reduce image distortion and rectify the stereoscopic pair of images 500. A multi-scale block matching process 510 between the two images may be used to match blocks of pixels with respect to one another for the pair of images. Using a multi-scale based technique tends to increase the accuracy and speed of the block matching process 510 for different scenes. A two dimensional disparity estimation process 520 may be performed by finding the optimal disparity values based on the block matching cost for each pixel. One embodiment is the “Winner-Take-All” strategy that selects the pixel with minimum matching cost

A three dimensional triangulation process 530 is performed with the estimated two dimensional disparities and the relative rotation and translation estimated by the camera calibration process. The rotation matrices R1, R2, and translation vectors T1 and T2 are precomputed by the calibration process. The triangulation process estimates the three dimensional depth by least squares fitting to at least four equations from the projective transformation models and then generates the estimated three dimensional coordinate of a point. The estimated point minimizes the mean square re-projection error of the two dimensional pixel pair. In this manner, the offsets between the pixels in the different parts of the image result in three dimensional depth information of the sensed scene.

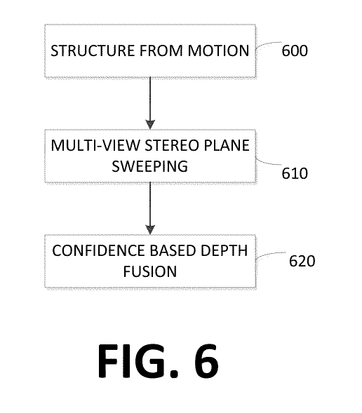

Referring again to FIG. 2, after calibrating each of the imaging devices the system may determine if multiple frames are available 210. If multiple pairs of stereoscopic images are available, then a multi-frame depth sensing process 230 may be used. Referring to FIG. 6, the correspondence between a series of image pairs of a sensed scene may be used for a three dimensional scene geometry estimation. In many cases, a structure from motion based technique 600 may be used to determine the three dimensional structure of a scene by analyzing location motion signals over time. In particular, the structure from motion may estimate extrinsic camera parameters by using feature points of each input image and the intrinsic parameters resulting from the camera calibration. Only a relatively few estimated parameters need to be determined for the structure from motion process while a few thousand feature points may be extracted from each image frame, thus defining an over determined system. Thus, the structure from motion process may reduce errors in the re-projection. A bundle adjustment may be used to reduce estimated parameters in a mean square error sense. Motion models may be incorporated to provide initializations to the bundle adjustment, which may otherwise be trapped in a local minimum.

By way of example, the first step of the bundle adjustment may be to detect feature points in each input image frame. Then the bundle adjustment may use the matched feature points, together with the calibration parameters and initial estimations of the extrinsic parameters, to iteratively refine the extrinsic parameters so that the distance between the image points and the calculated projections are reduced. The bundle adjustment may be characterized as follows:

$$\frac{min}{aj , bi} {\sum }_{i = 1}^{n} {\sum }_{j = 1}^{m} {v}_{ij} d ( Q ( {a}_{j} , {b}_{j} ) , {x}_{ij} )$$

in which xᵢⱼ is a projection of a three dimensional point bᵢ on view j, aⱼ, and bᵢ parameterize a camera and a three dimensional point respectively, Q(aᵢ, bᵢ) is a predicted projection of point bᵢ on view j, vᵢⱼ is a binary visibility term where if the projected point on view j is visible it is set to 1 and otherwise 0, and d measures the Euclidean distance between an image point and the projected point.

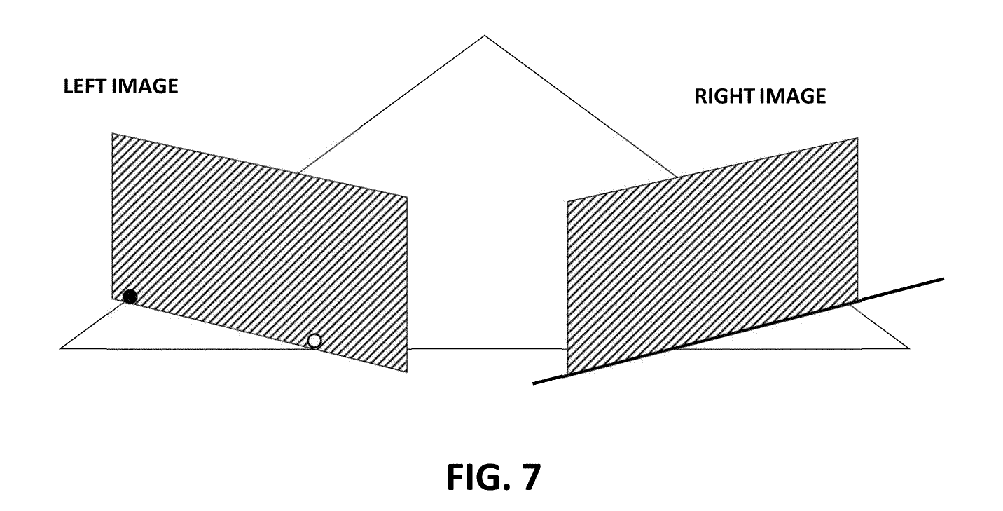

A multi-view stereo plane sweeping process 610 may be used to locate corresponding points across different views and calculate the depth of different parts of the image. Referring also to FIG. 7, the stereo plane sweeping process 610 may include a plane sweeping process to track three dimensional locations of image points by matching them across stereo image pairs. The plane sweeping process sweeps a hypothesized three dimensional plane through the three dimensional space in the direction of the principal axis of the reference camera and projecting both views onto the plane at every depth candidate. After both views are rendered to the plane at a certain depth, a cost value may be assigned to every pixel on the reference view to penalize two rendered pixels from being different with each other. The depth associated with the lowest cost value is selected as the true depth of the image point.

The cost value may be determined by using a matching window centered at the current pixel, therefore, an implicit smoothness assumption within a matching window is included. For example, two window based matching processes may be used, such as a sum of absolute differences (SAD) and normalized cross correlation (NCC). However, due to lack of global and local optimization, the resultant depth map may contain noise caused by occlusion and lack of texture.

A confidence based depth map fusion 620 may be used to refine the noisy depth map generated from stereo plane sweeping process 610. Instead of only using stereo images from current frame, previously captured image pairs may be used to provide additional information to improve the current depth map. Confidence metrics may be used to evaluate the accuracy of a depth map. Noise from current depth map may be reduced by combing confident depth estimates from several depth maps.

The confidence measurement implementation may use cost volumes from stereo matching as input and the output is a dense confidence map. Depth maps from different views may contradict each other, so visibility constraints may be employed to find supports and conflicts between different depth estimations. To find supports of a three dimensional point, the system may project depth maps from another view to the selected reference view, other three dimensional points on the same ray that are close to the current point are supporting the current estimation. Occlusions happen on the rays of the reference view, if a three dimensional point found by the reference view is in front of another point located by other views and the distance between two the points are larger than the support region. Another kind of contradiction is free space violation is defined on the rays of target views. This type of contradiction occurs when the reference view predicts a three dimensional point in front of the point perceived by the target view. A confidence based fusion technique may be used to update the confidence value of a depth estimate by finding its supports and conflicts, the depth value is also updated by taking a weighted average within the support region, then a winner-take-all technique is used to select the best depth estimate by choosing the largest confidence value, which in most cases is the closer position so that occluded objects are not selected.

The depth map fusion may be modified to improve the selection process. The differences include, firstly, allowing views to submit multiple depth estimates, so the correct depth values that mistakenly left out are given a second chance. Secondly, instead of using a fixed number as support region size, the system may automatically calculate a value which is preferably proportional to the square of depth. Third, in the last step of fusion, the process may aggregate supports for multiple depth estimates instead of only using the one with the largest confidence.

As a general matter, the stereo matching technique may be based upon multiple image cues. For example, if only a stereo image pair is available the triangulation techniques may compute the three dimensional structure of the image. In the event that the mobile device is in motion, then the plurality of stereo image pairs from different positions may be used to further refine the three dimensional structure of the image. In the case of a plurality of the stereo image pairs the depth fusion technique selects the three dimensional positions with the higher confidence to generate a higher quality three dimensional structure with the images obtained over time.

In some cases, the three dimensional image being characterized is not of sufficient quality and the mobile device should indicate to the user suggestions in how to improve the quality of the image. For example, the value of the confidence measures may be used as a measure for determining whether the mobile device should be moved to a different position in order to attempt to improve the confidence measure. For example, in some cases the imaging device may be too close to the objects or may otherwise be too far away from the objects. When the confidence measure is sufficiently low, the mobile device may provide a visual cue to the user on the display or otherwise an audio cue to the user from the mobile device, with an indication on a suitable movement that should result in an improved confidence measure of a sensed scene.

Three dimensional objects within a scene are then determined. For example, a planar surface may be determined, a rectangular box may be determined, a curved surface may be determined, etc. The determination of the characteristics of the surface may be used to interact with a virtual object. For example, a planar vertical wall may be used to place a virtual picture frame thereon. For example, a planar horizontal surface may be used to place a bowl thereon. For example, a curved surface may be used to drive a model car across while matching the curve of the surface during its movement.

Referring to FIG. 2, the rendering process may augment the three dimensional sensed image by rendering a three dimensional model at a specified location within the image and locating the virtual camera at the same location of the real camera 240. Suitable camera parameters are available from bundle adjustment process. A depth test may be performed between the depth buffer and the depth map generated from stereo matching process, with the smaller depth being kept and corresponding color information are selected as output.

By modeling the three dimensional characteristics of the sensed scene, the system has a depth map of the different aspects of the sensed scene. For example, the depth map will indicate that a table in the middle of a room is closer to the mobile device than the wall behind the table. By modeling the three dimensional characteristics of the virtual object and positioning the virtual object a desired position within the three dimensional scene, the system may determine whether the virtual object occludes part of the sensed scene or whether the sensed scene occludes part of the virtual object. In this manner, the virtual object may be more realistically rendered within the scene.

By modeling the three dimensional characteristics of the sensed scene, such as planar surfaces and curved surfaces, the system may more realistically render the virtual objects within the scene, especially movement over time. For example, the system may determine that the sensed scene has a curved concave surface. The virtual object may be a model car that is rendered in the scene on the curved surface. Over time, the rendered virtual model car object may be moved along the curved surface so that it would appear that the model car is driving along the curved surface.

With the resulting three dimensional scene determined and the position of one or more virtual objects being suitably determined within the scene, a lighting condition sensing technique 250 may be used to render the lighting on the virtual objects and the scene in a consistent manner. This provides a more realistic view of the rendered scene. In addition, the lighting sources of the scene may be estimated based upon the lighting patterns observed in the sensed images. Based upon the estimated lighting sources, the virtual objects may be suitably rendered based upon the estimated lighting sources, and the portions of the scene that would otherwise be modified, such as by shadows from the virtual objects, be suitably modified.

The virtual object may likewise be rendered in a manner that is consistent with the stereoscopic imaging device. For example, the system may virtually generate two stereoscopic views of the virtual object(s), each being associated with a respective imaging device. Then based upon each of the respective imaging device, the system may then render the virtual objects and display the result on the display.

It is noted that the described system does not require markers or other identifying objects, generally referred to as markers, in order to render a three dimensional scene and suitably render virtual objects within the sensed scene.

Light condition sensing refers to estimating the inherent 3D light conditions in the images. One embodiment is to separate the reflectance of each surface point with the light sources, based on the fact that visible color is resulted by the multiplication of surface normal and light intensity. Since the position and normal of surface points are already estimated by the depth sensing step, the spectrum and intensity of light sources can be solved by linear estimation based on a giving reflectance model (such as Phong shading model).

Once the light conditions are estimated from the stereo images, the virtual objects are rendered at the user specified 3D position and orientation. The known 3D geometry of the objects and the light sources inferred from the images are combined to generate a realistic view of the object, based on a reflectance model (such as Phong shading model). Furthermore, the relative orientation of the object with respect to the first camera can be adjusted to fit the second camera so that the virtual object looks correct from the stereoscopic views. The rendered virtual object can even be partially occluded by the real-world objects.

The terms and expressions which have been employed in the foregoing specification are used therein as terms of description and not of limitation, and there is no intention in the use of such terms and expressions of excluding equivalence of the features shown and described or portions thereof.

I/we claim:

1. A method for determining an augmented reality scene by a mobile device comprising:
(a) said mobile device accessing intrinsic calibration parameters of a pair of imaging devices of said mobile device in a manner independent of a sensed scene of said augmented reality scene;
(b) said mobile device determining two dimensional disparity information of a pair of images from said mobile device based upon a stereo matching technique;
(c) said mobile device estimating extrinsic parameters of a sensed scene by said pair of imaging devices, including at least one of rotation and translation;
(d) said mobile device calculating a three dimensional image based upon a depth of different parts of a said sensed scene based upon a triangulation technique;
(e) said mobile device incorporating a three dimensional virtual object in said three dimensional image to determine said augmented reality scene.

2. The method of claim 1 wherein said mobile device estimates three dimensional geometry and lighting conditions of the sensed scene based on one or more stereoscopic images sensed by a pair of imaging devices.

3. The method of claim 1 wherein said calibration parameters are based upon sensing at least one calibration image.

4. The method of claim 1 wherein said calibration parameters characterize an image distortion of said pair of imaging devices.

5. The method of claim 1 wherein said calibration parameters characterize a focal length of said imaging devices.

6. The method of claim 1 wherein said calibration parameters characterize a center of an image.

7. The method of claim 1 wherein said calibration parameters are based upon a projective transformation.

8. The method of claim 1 wherein said calibration parameters include distortion.

9. The method of claim 8 wherein said distortion is radial distortion.

10. The method of claim 1 wherein said extrinsic parameters are based upon structure from motion process.

11. The method of claim 10 wherein said structure from motion process includes the use of feature points.

12. The method of claim 11 wherein said structure from motion process includes a bundle adjustment.

13. The method of claim 12 wherein said bundle adjustment is further based upon said intrinsic calibration parameters and an estimation of said extrinsic parameters.

14. The method of claim 1 wherein said stereo matching technique includes block matching of at least one stereoscopic image pair.

15. The method of claim 1 wherein said stereo matching technique includes sweeping a plane across said sensed scene based on multiple stereoscopic images.

16. The method of claim 15 wherein said stereo matching technique includes sweeping said plane in a direction along a principal axis of the reference camera.

17. The method of claim 1 wherein 1 wherein said mobile device provides information to a user of said mobile device in how to modify obtaining said sensed scene.

18. The method of claim 1 wherein said three dimensional virtual object is rendered on non-planar surfaces in the sensed scene.

19. The method of claim 1 wherein said three dimensional virtual object is partially occluded by said three dimensional image in said augmented reality scene.

20. The method of claim 1 wherein said three dimensional image is said augmented reality scene is partially occluded by said three dimensional virtual object.

21. The method of claim 1 wherein lighting included with said augmented reality scene is based upon estimated lighting of said three dimensional image which is used as the basis for said lighting for said three dimensional virtual object.

22. The method of claim 1 wherein said augmented reality scene is based upon said three dimensional virtual object being rendered based upon each of said imaging devices.
